(19) United States
(12) Patent Application Publication
(10) Pub. No.: US 2009/0213354 A1
(43) Pub. Date: Aug. 27, 2009

(54) METHOD AND APPARATUS FOR PROJECTION PRINTING

(75) Inventors: Torbjorn Sandstrom, Pixbo (SE); Igor Ivonin, Goteborg (SE)

Correspondence Address: HAYNES BEFFEL & WOLFELD LLP, P O BOX 366, HALF MOON BAY, CA, 94019, US

(73) Assignee: MICRONIC LASER SYSTEMS AB, TABY (SE)

(21) Appl. No.: 12/063,228

(22) PCT Filed: Aug. 8, 2006
(86) PCT No.: PCT/SE2006/000932

§ 371 Date: Apr. 23, 2009

Related U.S. Application Data
(60) Provisional application No. 60/706,550, filed on Aug. 8, 2005.

(51) Int. Cl. G03B 27/72; G03B 27/32

(52) U.S. Cl. 355/71; 355/77

(57) ABSTRACT

A method, apparatus for and a device manufactured by the same, for printing a microlithographic pattern with high fidelity and resolution using simultaneously optimized illuminator and pupil filters having semi-continuous transmission profiles. The optimization can be further improved if the illuminator and pupil filters are polarization selective. The optimization method becomes a linear programming problem and uses a set of relevant features in the merit function. With a suitably chosen merit function and a representative feature set both neutral printing without long-range proximity effects and good resolution of small features can be achieved. With only short-range proximity effects OPC correction is simple and can be done in real time using a perturbation method.

### PRIORITY INFORMATION

This application claims the benefit of U.S. Provisional Application No. 60/706,550, entitled “Method and Apparatus for Projection Printing” filed on 8 Aug. 2005 by Igor Ivonin and Torbjorn Sandstrom.

### FIELD OF THE INVENTION

The present invention teaches a method to project an optical image of an original (typically a pattern on a photomask or a spatial light modulator (SLM)) onto a workpiece with extremely high resolution and fidelity given the constraints of the optics. Used with masks, it allows the mask to use less so called optical proximity correction (OPC), which pre-distorts or pre-adjusts a pattern to correct for optical deterioration that is normally found near the resolution limit. Therefore, patterns can be printed with the invention down to the resolution limit with high fidelity and only simple OPC processing or no OPC processing at all. With spatial light modulators (SLMs) as the image source, e.g. in mask pattern generators and direct-writing lithographic printers, the invention allows the same simplification. The SLM is driven by data from a data path and with the invention the data path need not apply OPC-like adjustments to the pattern data, or to apply less OPC adjustments, thereby simplifying the data channel. The invention is a modification of a partially coherent imaging system, and many partially coherent systems could use and benefit from the invention: e.g. photosetters, visual projectors, various optical copying machines, etc. The invention also works for image capture devices that use partially coherent light: optical inspection systems, some cameras, microscopes, etc. A generic partially coherent projection system is shown in FIGS. 1a-b.

### BACKGROUND OF THE INVENTION

A projected optical image is always degraded by the projection system due to optical aberrations and to the finite wavelength of light. Aberrations can be reduced by design, but the influence of diffraction of the light due to its finite wavelength puts a limit to the resolution and fidelity that can be achieved. This is well-know and many optical devices operate at the diffraction limit, e.g. microscopes, astronomical telescopes, and various devices used for microlithography. In microlithography, the size of the features printed limit the density of features that can added to the workpiece and therefore the value that can be added to the workpiece at each step. Because of the strong economic forces towards smaller and more numerous features on the workpiece, the optics used in lithographic processes are extremely well designed and limited only be the underlying physics, i.e. diffraction.

Many projection systems are designed as incoherent projectors. Coherence in this application means spatial coherence and is a way of describing the angular subtense of the illumination of the object (the mask, SLM, etc.) in relation to the angular subtense picked up by the projection lens. Incoherent in this sense means that the illumination as seen from the object has a larger angle range than what is transmitted by the projection lens. Tuning of the illumination angles has a profound influence on the image. The incoherent projection gives an image that is pleasing to the eye with a gradual fall-off of the contrast as one gets closer to the resolution limit. But for technical purposes, this fall-off means size errors for everything close to the resolution limit and the smallest features that can be printed with good fidelity are far larger than the resolution limit. In photography, the optical resolution is often determined as the smallest high-contrast object features that appear with any visible contrast in the image. For microlithography, the resolution is pragmatically determined as the smallest features that print with enough quality to be used. Since microlithographic patterns are imaged onto a high-contrast resist and the resist is further raised by the etching process, the quality in the image is almost entirely related to the placement and quality of the feature edges. Resolution is then the smallest size that, given the constraints of the process, gives acceptably small size errors (“critical dimension errors” or “CD”) and acceptably large process latitude. Resolution is, therefore, in lithography a stricter definition than in photographic imaging and is more determined by residual CD errors than by the actual limit of the optical system.

With partially coherent illumination, FIGS. 1 a-b, the angular range of the illuminator is limited to smaller than is accepted by the projection lens. This raises the useful resolution by introducing some amount of coherent “ringing” at the edges of the image. These ringing effects also affect neighboring edges and the image shows so called proximity effects: the placement of every edge depends on the features in the proximity to it. The illumination angles, i.e. the distribution of light in the illuminator aperture, can be tuned for higher useful resolution at the expense of more proximity effects and it becomes a trade-off between resolution and image fidelity.

The lithographic industry has raised the resolution by tuning the illumination and correcting residual errors by as much optical proximity processing in the mask data as it takes. As the requirements for both resolution and fidelity have risen, the OPC processing has become very extensive with model-based simulation of essentially whole chips. The OPC processing can be done using specialized software running on computer farms and still take several hours or even days. With OPC adjustments, a more aggressive illuminator can be used. Some historic figures illustrate this.

In the early 1990s, printed linewidths in microlithography were typically 0.70*lambda/NA, where lambda is as normal the wavelength of the light and NA is the sine of the opening half-angle of the projection lens. The factor lambda/NA is a constant for a particular type of equipment. In 2004, industry is printing 0.40*lambda/NA with OPC, sometimes down to about 0.30*lambda/NA, which means that five times more features can be printed using exactly the same optical limitations (lambda and NA). This requires heavy OPC correction in the masks. Correcting for the effects of the printing on the wafer adds cost, overhead and lead time. The extensive OPC corrections currently used in state-of-the-art products have produced an explosion of the data file size. At the 90 and 65 nm design nodes, pattern data files may be 50 Gbyte or more in size and even the transmission and storage of the files becomes a burden to the design houses and mask shops. Adding one more layer of OPC corrections for the printing of the mask in an SLM-based pattern generator would add more cost, overhead and make the lead time even longer.

Therefore, there is a need in the art for an improved method for printing highly accurate patterns. It is an object of the present invention is to optimize the optics in order to lessen or even remove the need for optical proximity correction. It can be applied in the maskwriter, in a direct-writer or in mask-based lithography.

### SUMMARY OF THE INVENTION

We disclose a method to project an optical image onto a workpiece with extremely high resolution and fidelity, given the constraints of optical components. Particular aspects of the present invention are described in the claims, specification and drawings. In view of the foregoing background, the method for printing highly accurate patterns is useful to improve the performance of such patterns and the time it takes for printing said patterns.

Accordingly, it is useful to improve the optics in order to lessen or even remove the need for optical proximity correction. The methods disclosed can be applied in a maskwriter, in a direct-writer or in mask-based lithography. The present application teaches a different method of printing features down to below 0.30*lambda/NA without OPC or with relatively little OPC. The gains are obvious: less cost, less complexity, simpler mask, shorter lead times and less overhead. The benefits are significant when printing from masks, and even larger when the object is an SLM.

In an example embodiment, we disclose a method for printing highly accurate patterns, e.g. in microlithography, including providing an image object, providing a workpiece, providing an illuminator illuminating the object and having an illuminator aperture function, further providing an optical projection system having in the projection pupil a pupil function and forming a partially coherent image on the workpiece, where said projection aperture function has a continuous or semi-continuous variation with the pupil coordinate.

In another example embodiment, we disclose an apparatus for printing highly accurate patterns, e.g. in microlithography, comprising an image object, a workpiece, an illuminator illuminating the object and having an illuminator aperture function, an optical projection system having in the projection pupil a pupil function and forming a partially coherent image on the workpiece, where said projection aperture function has a continuous or semi-continuous variation with the pupil coordinate.

In another example embodiment, we disclose a method for printing highly accurate patterns, e.g. in microlithography, including providing an image object, providing a workpiece, providing an illuminator illuminating the object and having an illuminator aperture function, further providing an optical projection system having in the projection pupil a pupil function and forming a partially coherent image on the workpiece, where the projection aperture function and the pupil function are chosen to provide good fidelity for a set of different feature types.

In another example embodiment, we disclose a method for design of an illuminator aperture and a matching pupil functions in a partially coherent projection system including providing a simulator for the partially coherent image, providing a description of the optical system, providing restrictions on the optical system, further performing an optimization of the image fidelity by modifying said two functions.

In another example embodiment, we disclose a method for printing a microlithographic pattern with reduced OPC correction above a specified interaction length including providing an illuminator aperture function, providing a pupil function, said functions being chosen to give essentially flat CD linearity for at least two and preferably a least three feature types above a linewidth essentially equal to said interaction length.

### BRIEF DESCRIPTION OF THE DRAWINGS

Reference is now made to the following description taken in conjunction with accompanying drawings, in which:

FIG. 1a: Simple partially coherent projection system with illumination and projection stops defined.

FIG. 1b: Partially coherent projection system using reflecting objects, such as an SLM or an EUV mask.

FIG. 1c: Partially coherent projection system using an SLM and relays in the illuminator and projection paths.

FIG. 2a: Projection system with a pupil filter and a varying illumination function, either from a filter or from a diffractive optical element (DOE).

FIG. 2b: Projection system with an accessible pupil plane, and a pupil filter implemented by an absorbing, reflecting or phase-shifting binary pattern with features small enough to diffract light outside of the pupil stop.

FIG. 2c: Projection system with immersion, an angle-dependent thin-film reflector as a polarization-selective pupil filter and a polarization filter in the illuminator.

FIG. 3a: Showing semi-continuous functions.

FIG. 3b: Rotationally symmetrical functions.

FIG. 3c: Non-rotationally symmetrical function with symmetry for 0, 90, 180 and 270 degree features.

FIG. 4: Flow-chart of a method of optimization of the aperture functions.

FIG. 5: Optimization of the aperture functions in a preferred embodiment with NA=0.82, obscuration=16%, and lambda=248 nm showing the merit fence and the CD linearity and an edge trace.

FIG. 6: Aperture functions in a preferred embodiment with NA=0.90, 16% obscuration, lambda=248 nm, and radial (p) and tangential (s) polarization.

FIG. 7: Corresponding CD linearities.

FIG. 8: Aperture functions in a preferred embodiment with NA=0.90, 11% obscuration, lambda=248 nm and no polarization.

FIG. 9: CD linearity curves using the apertures in FIG. 8.

FIG. 10: Aperture functions in a preferred embodiment with NA=0.90, no obscuration, lambda=248 nm and no polarization.

FIG. 11: CD linearity curves using the apertures in 10.

FIG. 12: CD linearity curves using the apertures in 10 showing the effect of defocus.

FIG. 13: Three features, two clear and one shifted, the aerial image through focus and the imaginary part of the E field that gives symmetry through focus.

FIG. 14: Three sets of features for simultaneous optimization.

FIG. 15: A single set of features that, if the pixels are smaller than the resolution of the optics, represents all possible patterns.

FIG. 16: A non-linear filter that corrects the residual CD linearity error.

FIG. 17: Flowchart of a method for fast OPC correction, working in the raster domain.

FIG. 18: Flowchart of a method for fast OPC correction, working in the vector domain.

FIG. 19a: Two equivalent ways of implementing a pupil filter in the projection aperture. In 19a, the pupil filter 191 varies as a function of position in the aperture plane of the projection lens 190.

FIG. 19b: The same effect is achieved with a filter 192 with an angle-dependent transmission in a plane where the beams are converging, here close to the image plane.

FIG. 20a: Two ways of achieving the same intensity distribution in the illuminator aperture. 20a shows a beam expander 201, 203 expanding the beam from the laser and shaping it with a transmission filter. 20b shows the same laser beam dispersed with a diffractive element 205 which directs the beam energy into a spatial distribution equivalent to the one in 20a.

FIG. 20b: Shows the same laser beam dispersed with a diffractive element 205 which directs the beam energy into a spatial distribution equivalent to the one in 20a.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

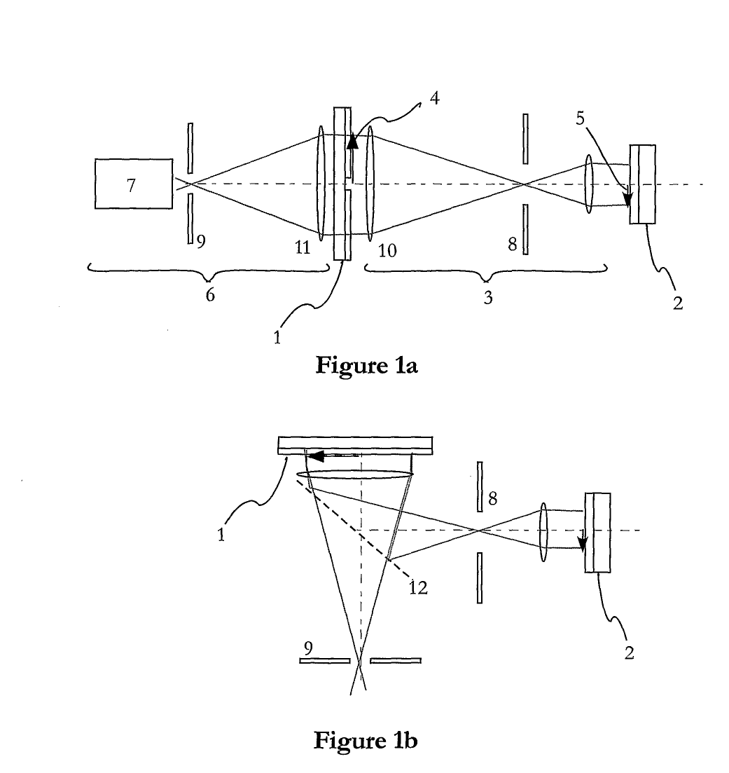

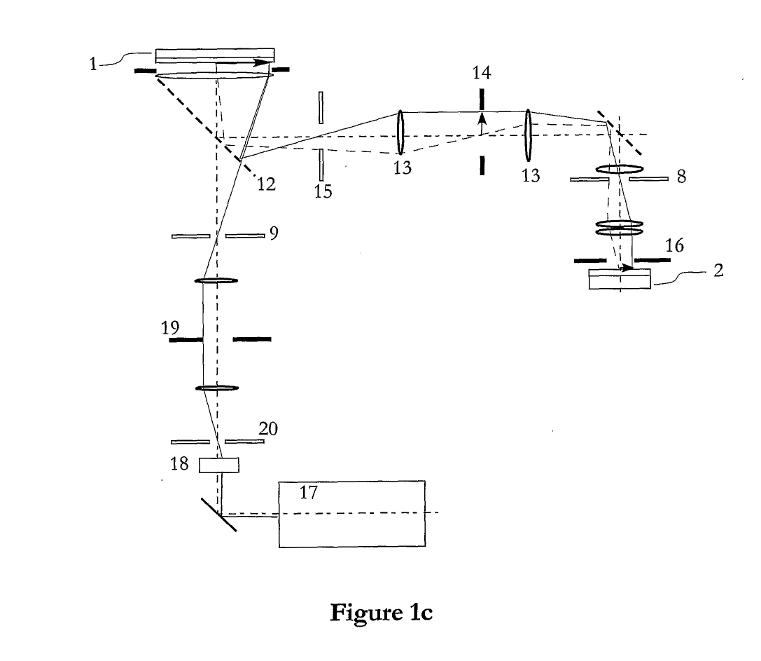

A generic projection system has been defined in FIG. 1a. It has an object 1, which can be a mask or one or several SLMs, and a workpiece 2, e.g. a mask blank, a wafer or a display device. Between them is a projection system 3 creating an image 5 of the image 4 on the object. The object is illuminated by an illuminator 6. The projection system consists of one or several lenses (shown) or curved mirrors. The NA of the projection system is determined by the size of the pupil 8. The illuminator 6 consists of an essentially non-coherent light source 7 illuminating the illumination aperture 9. Field lenses 10 and 11 are shown but the presence of field lenses is not essential for the function. The imaging properties are determined by the size and intensity variation inside the illuminator aperture 9 in relation to the size of the pupil 8. The term partially coherent beam indicates that the illuminator aperture is smaller than the pupil, but not infinitely small.

The basic projection system in 1a can be realized in many equivalent forms, e.g. with a reflecting object as shown in FIG. 1b. The imaging power of the optical system can be refractive, diffractive or residing in curved mirrors. The reflected image can be illuminated through a beam splitter 12 or at an off-axis angle. The wavelength can be ultraviolet or extending into the soft x-ray (EUV) range. The light source can be continuous or pulsed: visible, a discharge lamp, one or several laser sources or a plasma source. The object can be a mask in transmission or reflection or an SLM. The SLM can be binary or analog; for example micromechanical, using LCD modulators, or using olectrooptical, magnetooptical, electroabsorbtive, electrowetting, acoustooptic, photoplastic or other physical effects to modulate the beam.

FIG. 1c shows a more complex implementation of the basic structure of FIG. 1b: the principal layout of the optics for the Sigma7300 mask writer made by Micronic Laser Systems AB. It has an excimer laser 17, a homogenizer 18, and relay lenses 13 forming an intermediate image 14 between the SLM and the final lens. The pupil of the final lens is normally located inside the enclosure of the final lens and difficult to access, but in FIG. 1c there is an equivalent location 15 in the relay. The smallest of the relay and lens pupils will act as the system stop. There is also a relay in the illuminator providing multiple equivalent planes for insertion of stops and baffles. The Sigma7300 has a catadioptric lens with a central obscuration of approximately 16% of the open radius in the projection pupil.

The size of the illumination aperture and the intensity distribution inside it have a profound effect on resolution and image fidelity. A ring with inner/outer diameters of 0.2/0.6 of the system pupil give neutral imaging with a good trade-off between resolution and fidelity. Other intensity distributions like a four-pole or a two-pole enhance certain features at the expense of others. In a pattern with varying line widths or varying pitch, it is nearly always necessary to do an optical proximity correction of the printed features are below 0.5 NA/lambda.

One may modify the resolution and fidelity of fully coherent systems by so called apodization, i.e. a modification of the light distribution in the pupil. Normally this is done in order to increase or decrease the depth of focus or to decrease the size of the central diffraction lobe.

### Brief Description

We disclose methods to modify a partially coherent projection system for higher resolution and image fidelity. The pupil transmission is modified and optimized for improved image fidelity and reduced need for OPC correction of the pattern. Simultaneously, the intensity distribution in the illumination aperture is optimized to support the pupil function and interact with it so as to produce good image fidelity.

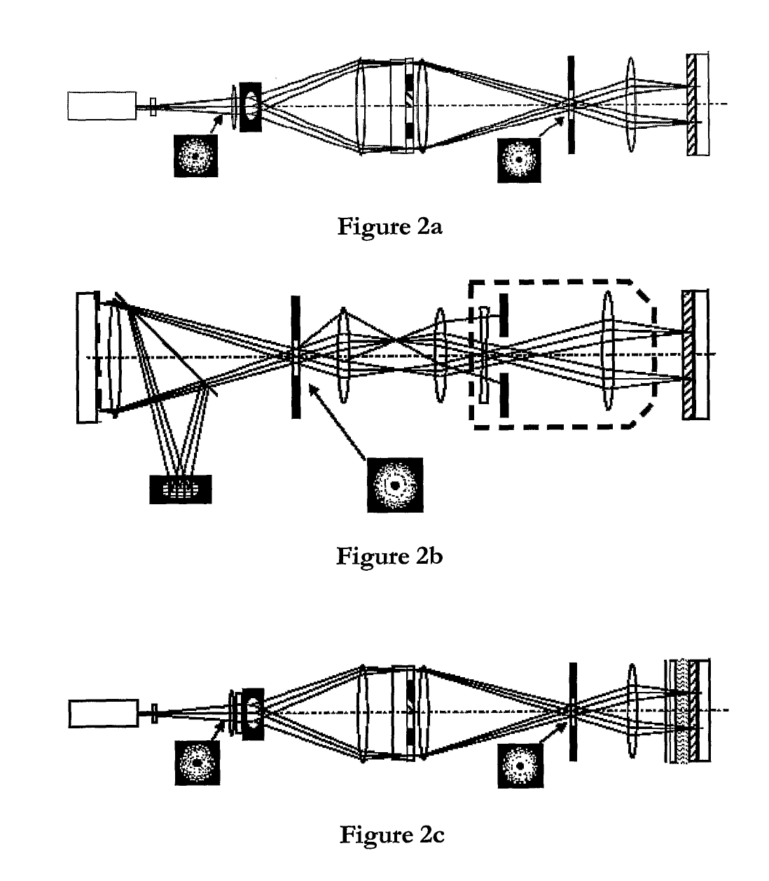

Optimized CD linearity for 65 nm node: resolution is 8 mm when keeping ±2 nm CD error restriction above CD=240 nm. FIG. 2 shows the same generic system as in FIG. 1a, with the addition of a pupil filter 21 and an illumination aperture filter 22. Using two transmission filters is the simplest embodiment disclosed. The two filters can be described by a pupil function and an illuminator aperture function describing the transmission through the filters. The pupil filter is complex, i.e. both phase and magnitude of the transmission are specified. The illuminator aperture filter is an intensity filter, i.e. the phase is arbitrary. The functions have a continuous or semi-continuous variation with the pupil and aperture coordinate coordinates. Continuous means the same as a continuous function, it does not have steps. However, due to manufacturing and design restrictions, the functions need to have discontinuities. A designed varying continuous phase may be manufactured as a stepwise varying function. Likewise, truncation of the function at the edges of the aperture can be discontinuous. We will call such functions that approximate continuously varying functions over at least part of the area of the filter semi-continuous.

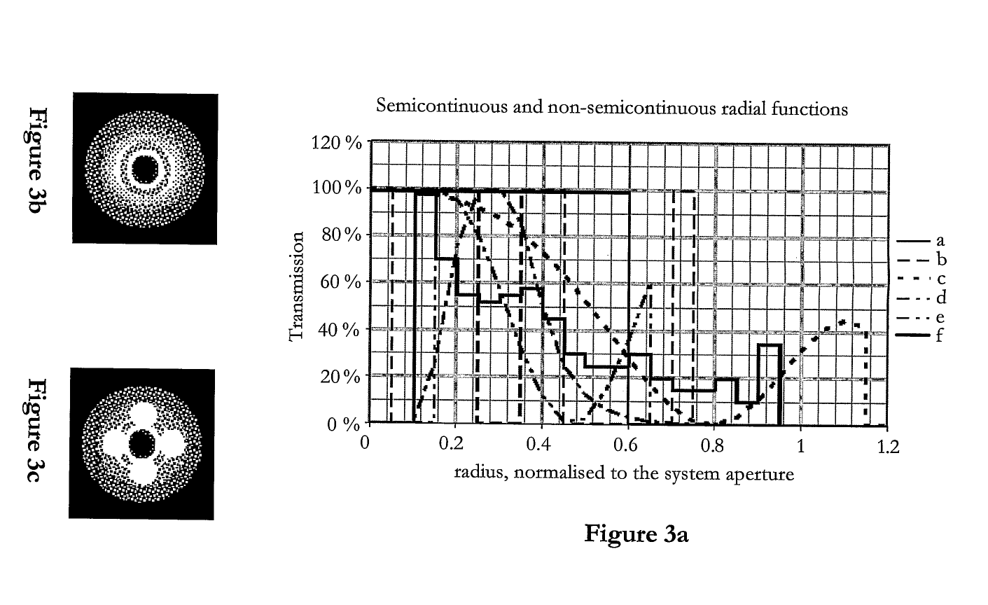

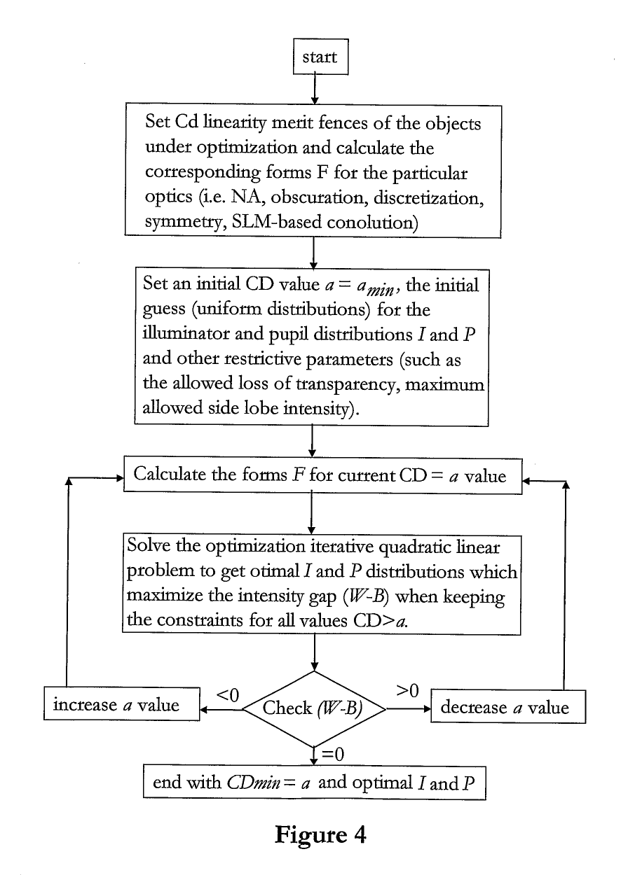

### FIG. 3

FIG. 3a shows the results of applying hypothetical examples of pupil and/or illuminator functions. Line a is a top-hat disk function. Line b a more complex function with varying transmitting and non-transmitting rings. Lines c-f show a selection of semi-continuous functions. Line e is a fully continuous function, while lines c and d show functions that are continuous but truncated. Finally, line f shows a piecewise flat approximation of a continuous but truncated function. Line f displays several interesting features: First it shows a “pile-up” close to the truncation edges at 0.10 and 0.90. Secondly, it is a basic smooth function with a superposed ring pattern with maxima at 0.47, 0.62, and 0.82. Both these features are commonly found in the optimization functions. FIGS. 3b-c are examples of illuminator and pupils for 65 nm node. Restriction for maximum allowed 90% side lobe intensity level (from the nominal intensity) is applied. Ten radial harmonics were used both for pupils and for the illuminator. The illuminator is represented by 60×60 grid pixels.

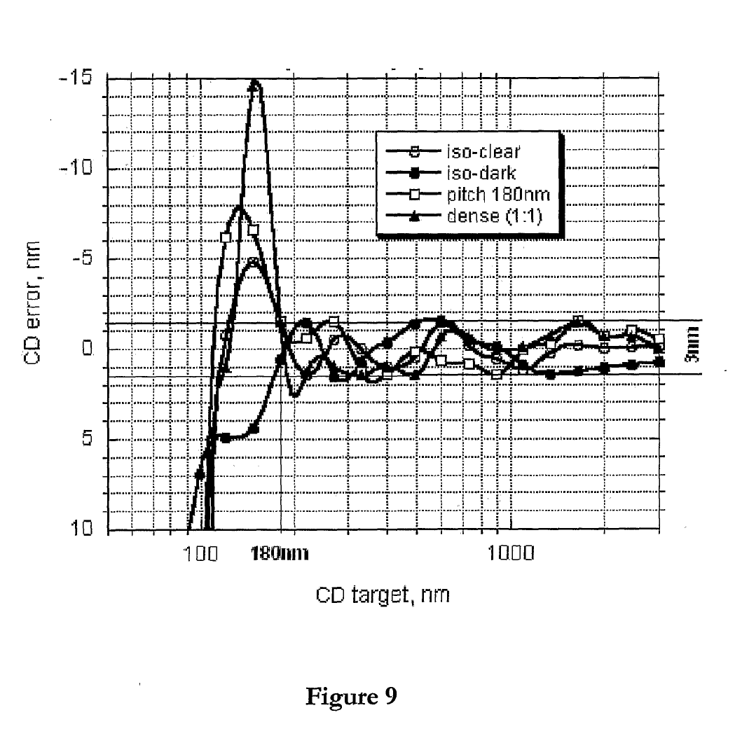

FIG. 9 is an example of optimized CD linearity for 45 nm node.

CD linearity profiles are within 3 nm CD error range above CD=180 nm. Final lens with 11% obscuration is used.

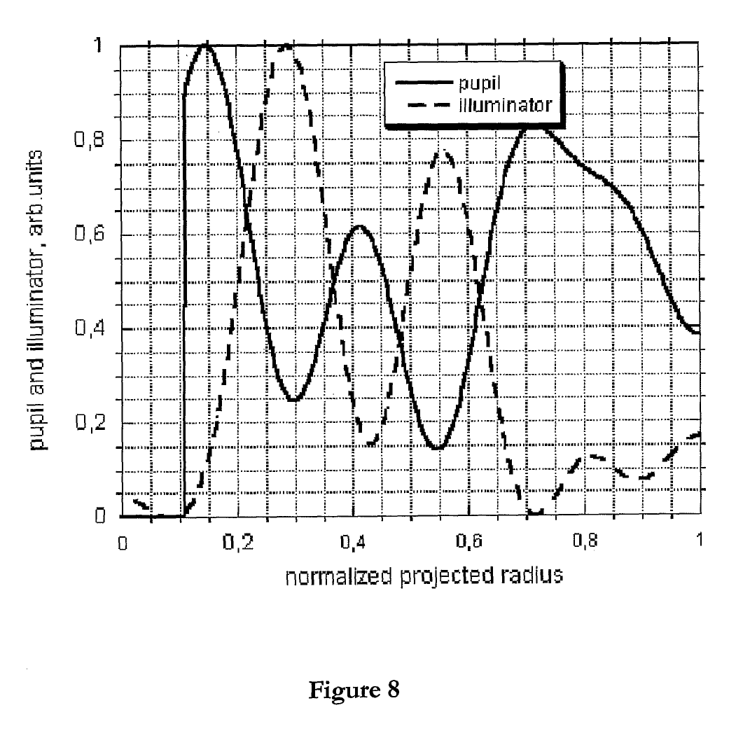

FIG. 8 is an example of optimized illuminator and non-polarized pupil for 45 nm node. 20% restriction for minimum allowed transparency is applied. Self-consistency in the pupil and illuminator distributions is clearly seen.

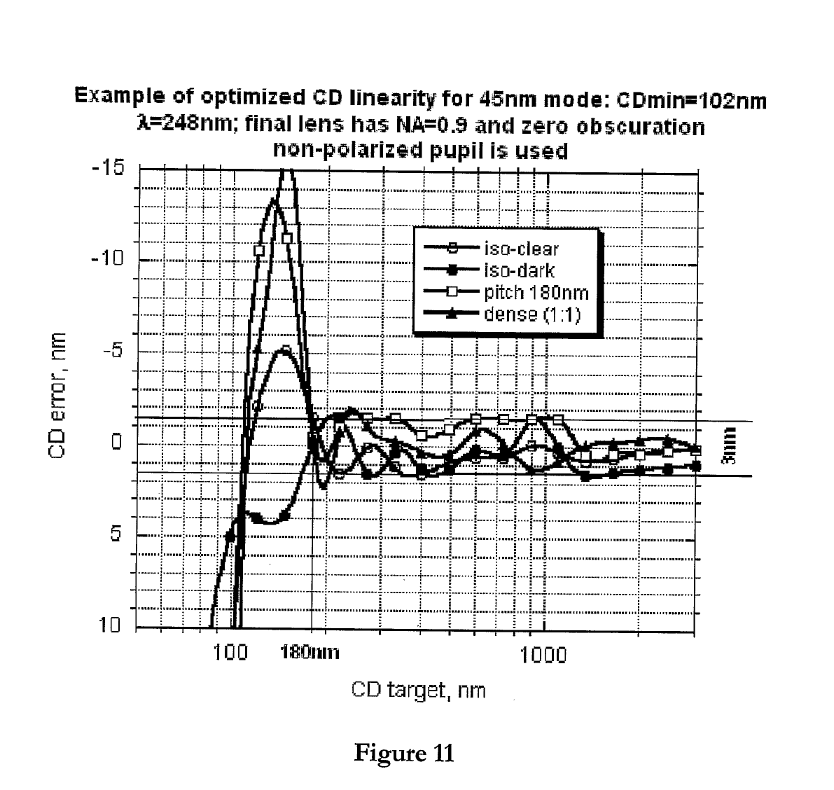

FIG. 11 is an example of optimized CD linearity for 45 nm node for the lens without obscuration. CDmin value is similar to that in FIG. 9. FIG. 3c is an illuminator function that extends outside of the radius of the system aperture. This is equivalent to adding a small amount of dark-field imaging in a microscope and aids in optimizing the coherency function of the mask or SLM plane.

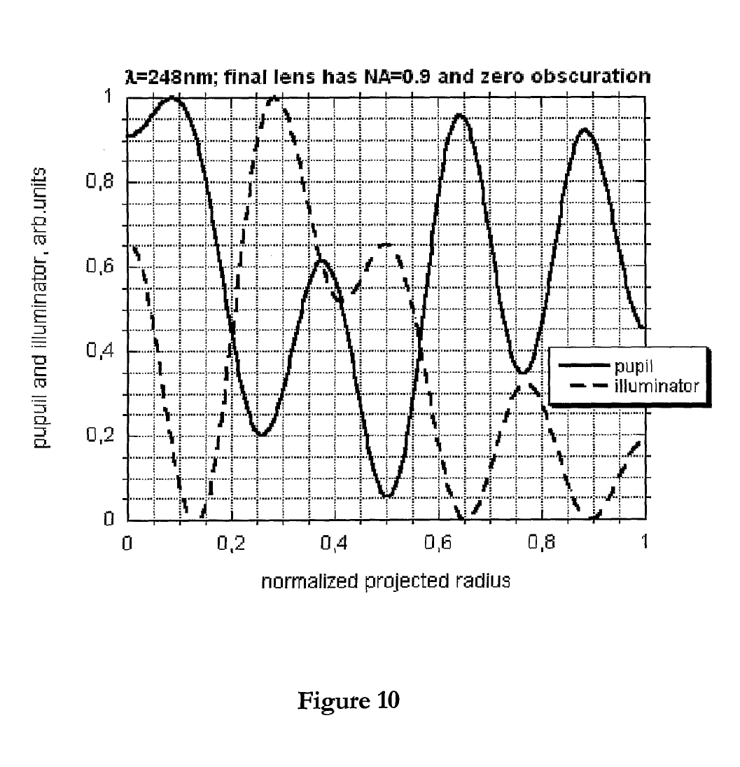

FIG. 10 is an example of optimized illuminator and non-polarized pupil for 45 nm node. A final lens without obscuration is used. Compare with FIG. 8.

FIG. 11 is the CD uniformity in focal region. The CD curves in focal plane (solid curves) are the same as in other designs.

The aperture stop has a transmission that varies in a more complex fashion. In general it can be complex, i.e. it can the phase specified as well as the magnitude.

Furthermore, the transmission varies in a more complex way than the simple clear ring that is used in Sigma7300. One preferred embodiment has a phase that is everywhere 0 but an intensity transmission that is a continuous function of the radius. Another preferred embodiment has the phase 0 and a stepwise varying transmission. A third embodiment has a phase that varies in a continuous fashion, and fourth embodiment has a phase that varies in a stepwise fashion. In a fifth embodiment, both the transmission and the phase vary. In a sixth embodiment, the transmission function is a combination of continuously and stepwise varying parts. A seventh embodiment uses a function that combines continuously and/or stepwise varying transmission with a continuously and/or stepwise varying phase. In an eighth embodiment, the aperture stop is at each point described by a complex number and the complex number varies continuously and/or stepwise over the area of the stop.

Additionally, the illumination can vary over the illumination pupil. This variation can be created in several ways, e.g. by an absorbing filter before the object, preferably near the illumination stop or an optically equivalent plane, or by a diffractive optical element (DOE) before, at, or after the stop. Whatever the method for creating the variation, the illuminating intensity vs. angle function at the object plane has an intended variation more complicated than the simple clear ring with inner and outer sigmas of 0.20 and 0.60 used in the Sigma7300. The quantity sigma, often used in lithography, is the relation of a radius in the illuminator and the outer radius of the projection stop compared when they are projected to the same plane, e.g. in the plane of the projection stop. The variation of the intensity in the illumination stop (or the equivalent variation if it is created after the stop) can be described by a continuous or stepwise function or a function with a combination of continuously and stepwise varying parts.

Furthermore, the illumination light can have a polarization direction (or more generally polarization state) that varies over the stop and optionally between different writing passes and writing modes. The projection stop, or an equivalent plane, can have a polarization-modifying property that varies over the surface and/or between writing passes and writing modes. The description where the stop could at each point be described by a complex number is then generalized to a Mueller matrix. A Mueller matrix can change the state of polarization and the degree of polarization, thereby representing polarizers and depolarizers, as well as wave-plates and polarization rotators, as described in Azzam and Bashara “Ellipsometry and polarized light”. Each matrix element is a function over the area and can vary continuously or stepwise according to the invention. If the projection stop is described by Mueller matrices, it is convenient to describe the illumination by Stokes vectors that represent intensity, polarization state and degree of polarization, as described in the textbook reference.

The variation at both projection and illumination stops can be fully rotationally symmetrical or it can be symmetrical under a rotation of 180, 90 or 45 degrees only. It can also be non-centro-symmetric with no rotation symmetry.

For simplicity, we will call the variations filters. The pupil filter describes the variation in the projection lens aperture plane or an equivalent plane. The illumination filter is the variation of the illumination versus angle as seen from the object, represented by an equivalent filter at the illuminator stop. It is useful to improve the printing resolution and fidelity the filters with a design for the printing case at hand. The connection between the pupil functions and the printing properties is complex and can only be analyzed by means of specialized software.

### Optimization

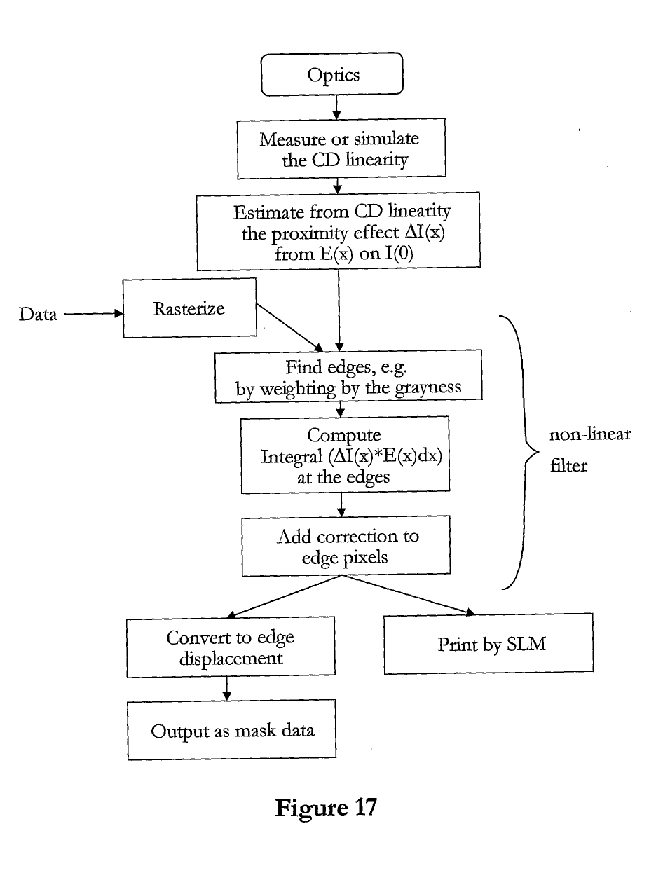

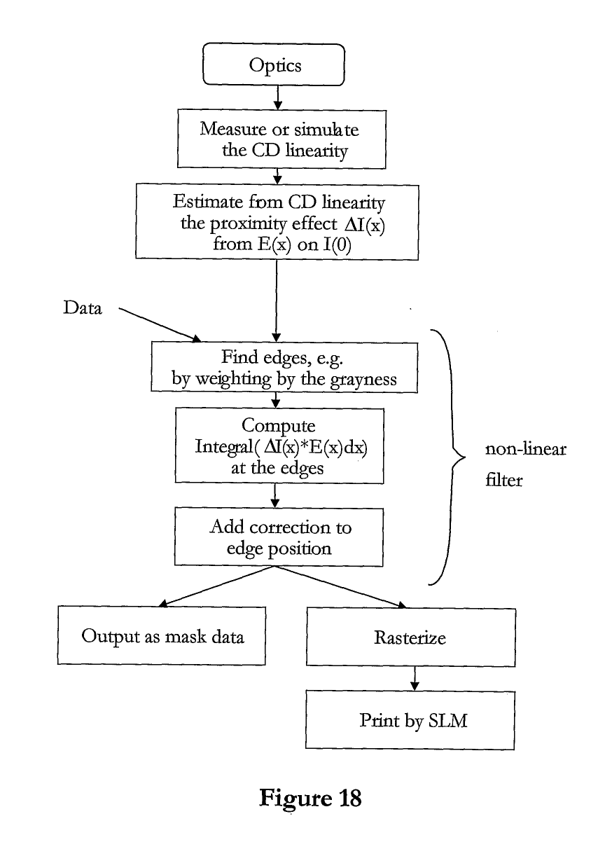

FIGS. 17 and 18 show the structure of the optimization program. It has two parts, the image simulator and the non-linear optimization routine, wrapped in a shell program that administrates the data flow and input/output written in, for example, MATLAB.

The image simulation routine can be a commercial image simulator, see above, or a custom-developed routine. There are a number of known ways to compute the image, e.g. by the so-called Hopkins' method or by propagation of the mutual intensity. Commercial software packages that can calculate the printed image from the optical system include Solid-E from the company Sigma.C in Germany, Prolith from KLA and Panoramic from PanoramicTech, both in the USA. For simulation of high-end lithography, the image should be computed with a simulator that is aware of high-NA effects, polarization and the electromagnetic vector nature of the light.

For the non-linear optimization, there are well-known methods and commercial toolboxes, for example in MATLAB and Mathematica and in libraries from NAG and IMSL, all well-known to most mathematical physicists. The optimization routine should handle constraints gracefully. The existence of multiple local optima should also be taken into account. This is no different from optimization in optical design, to give one example, and methods are known to handle these difficulties, e.g. parameter space sampling, simulated annealing, etc. A textbook on the subject is Ding-Zhu Du et al. “Mathematical Theory of Optimization.”

The inventors have developed a self-contained code doing both image simulation and optimization in FORTRAN using the IMSL mathematical library for the optimization. The imaging routine has been benchmarked against the high-NA vector model of Solid-E for accuracy.

### Merit Function

One chooses a merit function for the optimization. The number of possible patterns in the neighborhood within, say, 500 nm around an edge is immense and to optimize all of them would be difficult. The inventors have found that analysis of a small set of pattern classes is sufficient for rotationally symmetric aperture functions. This set of classes is one-dimensional lines with different pitch and duty factor. The printed pullback from a corner is a function of how very thin lines print, but the pullback can also be added explicitly to the merit function. Likewise line-end shortening can be deduced from the properties of lines at the resolution limit, or it can be added explicitly to the merit function.

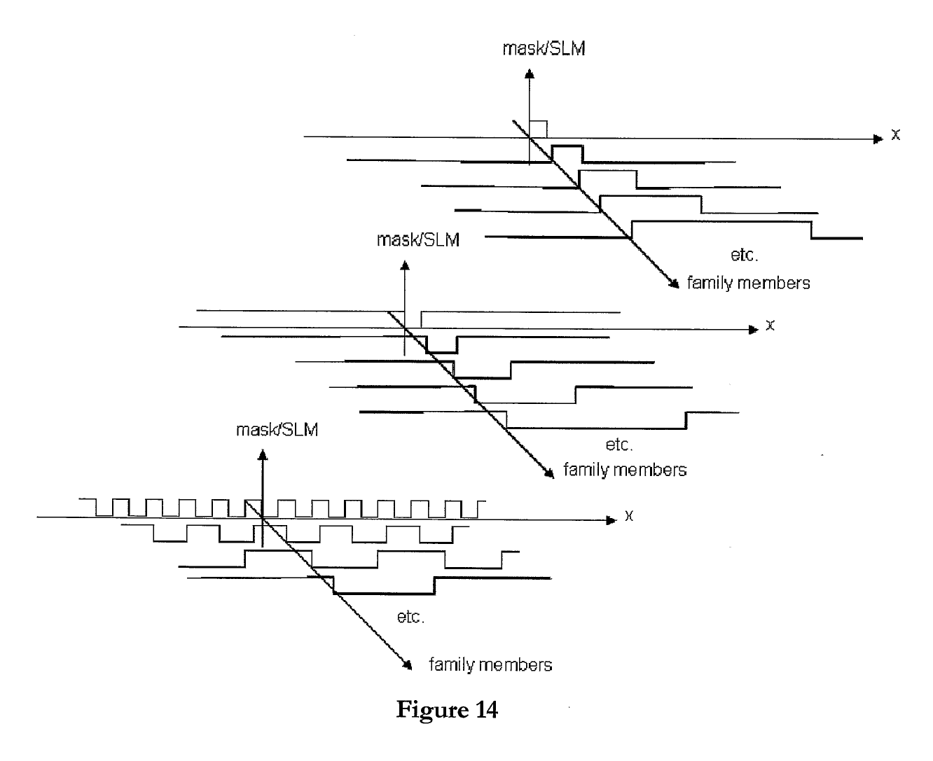

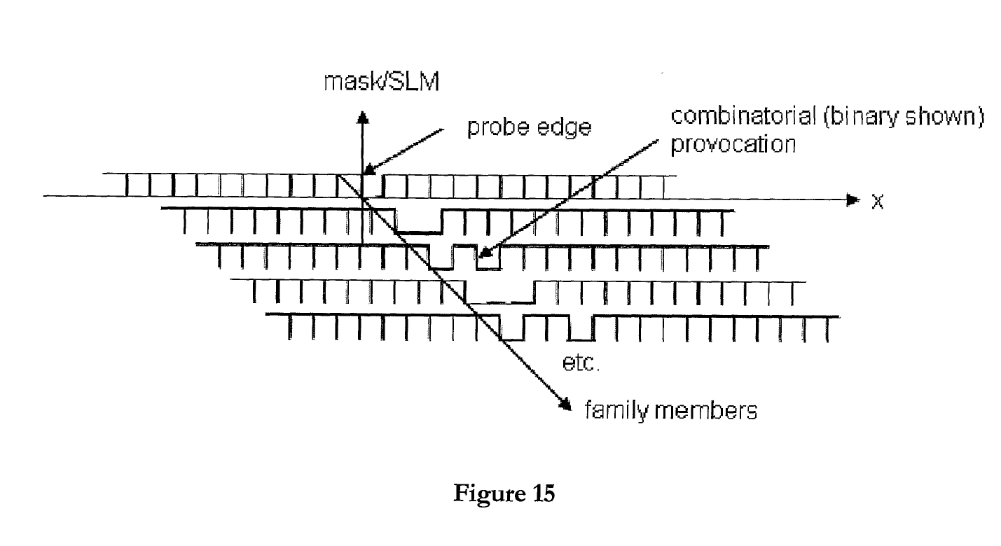

The inventors have worked with optimization of three classes of features: isolated dark lines, isolated exposed lines and dense lines and spaces, all with the linewidth varying from below the resolution limit to about ten times larger. See FIGS. 14 and 15. The printed size has been compared to the nominal size and the difference has been minimized over a range of sizes. This is plotted in what we call a “CD linearity plot”, FIG. 22. “CD” means Critical Dimension and in this case the same as “linewidth”. Since in applications “CD through pitch”, i.e. linewidth errors for lines, usually dark, with constant linewidth but with different line-to-line pitch, is an important quality metric we have also added this as a separate class of features.

The merit function is set up to fulfill some or all of the following objectives. The first one is to make all lines larger than a specified limit print with no CD errors, i.e. to make the CD linearity plot flat above the limit. If all feature classes satisfy this there is no influence between edges at a distance larger than the limit. This is a large benefit, since it limits the range of the OPC adjustments needed to make a pattern print accurately. During the OPC processing of a pattern the computational load depends strongly on the range of interactions that need to be analyzed, and the objective here is to limit that range. We will call it the limit of no interaction.

The second objective is to make the resolution as high as possible, i.e. to make the linewidth where lines no longer print as small as possible. Different criteria for the resolution can be used, e.g. when the line does not print at all or when it has a specific size error. We have been using a size error of −5 nm as the limit. Even if the pattern does not contain lines that are at the resolution limit, this objective is important because if makes all corners sharper and cleaner.

The third objective is to bring lines between the resolution limit and the limit of no interaction within acceptable bounds. Physics does not allow all lines to be printed perfectly and the optimal solution is a trade-off. If the limit of no interaction is allowed to be higher and the resolution limit lower, the intermediate range can be made better. Depending on the application and the tolerances it can be brought within acceptable bounds or it will need some adjustment in the data going to the SLM or to the mask writer in the case of a mask.

FIG. 9 shows four graphs which are the linewidth errors (“CD errors”) of isolated lines (unexposed) and spaces (exposed), a dense line/space pattern with 50% duty cycle and a CD through pitch pattern with 130 nm dark features and varying pitch. The lines marked with dots in FIG. 9 are “fences” that are limits outside of which the graphs are not allowed to go. The merit function used in this case allows any variation inside the fences and optimizes the resolution at −5 nm error for isolated clear and dark features. The pitch pattern behaves different from the other patterns, which is natural since compared to the dense pattern it has a wider line and a narrower space below 130 nm in the graph.

Before the optimization, the solution space is scanned for solutions that touch the fence. Several different solutions representing local optima under the constraints of the fences are found and compared. The best one is selected for numerical optimization. The inventors believe that this is a good way of finding the global optimum under the constraints applied. There are more constraints than the fences: in the case the inventors have worked most, there is a central obscuration in the final lens, and there are constraints on the total transmission. Other methods of finding the global optimum are possible as outlined above.

If the constraints are changed, e.g. the size of the obscuration is changed or the shape of a fence is modified, the shape of the aperture functions changes accordingly. There are several solutions branches possible and for some input parameter changes the optimization pursued jumps from one branch to another. Again, this is typical of non-linear optimization and gives the result that small changes in the assumptions and inputs may cause dramatic changes in the optimal aperture functions. The inventors have found that the amount of obscuration has a dramatic influence on the shape of the optimal functions and also on the optimality of the solutions.

### Adjustment of Data in the Intermediate Range

The linewidth range between the limit of no interaction and the resolution limit cannot be printed without errors depending on neighboring features and edges. This is, in fact, the definition of the limit of no interaction. However, this adjustment is much easier than full OPC and involves only closest-neighbor influences, perhaps just an edge bias depending on the distance to the next edge on each side.

In a maskwriter or direct-writer with one or several SLMs, the pattern adjustments at this intermediate interaction length can be done in the bitmap based on local information available in the rasterizer during the raster processing. Such operations can be implemented in high-speed programmable logic and can be pipe-lined with other data processing, i.e. they occur concurrently with the rasterization and add no overhead or pre-processing time to the job. In an alternative datapath architecture, based on rasterizing to memory by one or several processors before the pattern, the local bitmap operations can either be pipe-lined to separate processors or done subsequently to the rasterization by the same processors. The first case generates little delay, the second case does add significant delay, but a delay that may be acceptable given the fidelity improvement and constraints and trade-offs in the specific case.

The OPC pre-processing needed without the technology disclosed is much larger due to the long interaction ranges created by aggressive illumination schemes (quadrupole, dipole, etc.) Several features affect every edge and the pre-processing needs to be done in the vector domain, i.e. in the input data file. Furthermore, changes in the input pattern created by the OPC pre-processing often makes a new design-rule check necessary and can lead to an iterative workflow which increases the workflow further. With the technology disclosed the processing can still be done in the vector domain, e.g. in the data input to a maskwriter, but the OPC pre-processing workload is smaller and faster. After the optimal functions have been applied to the aperture filters, the remaining errors are small and need little adjustment, if any.

Going back to the bitmap processing for a maskwriter or direct-writer, the corrections are rather small and have a simple relation to the features inside the limit of no interaction. A suitable method to do the correction is by convolution of the bitmap by a kernel that corrects for the residual errors. Such bitmap operations have been described in relation to SLMs with negative complex amplitude in a patent application by the same applicant. However, the bitmap operation for correcting residual CD-linearity errors need not be limited to SLMs using negative amplitude. Any bitmap representing an image can be corrected for short-range interactions in the same way.

In a further elaboration, the bitmap operations are asymmetric between light and dark features, so that exposed and unexposed thin lines get corrected by different amounts. This can be implemented by a modified convolution, where the added adjustment of a pixel is a non-linear function of the values of the neighbors, possibly also of the value of the same pixels.

The curves in FIG. 9 are generated from the image formed in the resist, not from the developed resist image. In the simplest model of the resist, the entire thickness of the resist is dissolved (in a positive resist, opposite negative ones) when the exposure dose is above a threshold dose at the top of the resist. This corresponds to the model behind FIG. 9. A real resist has a somewhat more complex behavior with non-zero optical absorption, finite contrast, geometric transport-limitation and shadowing during the development and etching, plus a range of reaction and diffusion phenomena during the post-exposure baking (chemically amplified resist). Typically, thin spaces (exposed lines) are more difficult to form in the resist than lines (unexposed). The optical absorption in the resist makes the space narrower towards the bottom of the resist and progressively more difficult to develop. As a pre-compensation for this, it is advantageous to allow the optical image of the exposed lines to have higher positive linewidth errors than unexposed ones in the intermediate linewidth range.

With bitmap processing (and also processing in the vector domain) it is possible to adjust the two types of lines differently to pre-compensate for the effects of the resist. Since the processing of data is a software or programmable operation, it is possible to measure the errors created by the process and include them in the adjustments of the data. This gives a flexibility to the combination of optimized aperture functions and tuned adjustment of the data that can yield close to perfect printing results on real patterns with little or no pre-processing. The inventors believe that general arbitrary patterns can be printed neutrally with errors consistent with industry roadmaps down to less than 0.3*lambda/NA.

### Transmission

There is a price to pay for the good fidelity: low optical transmission. Looking at the curves in FIG. 10 showing the aperture functions one finds that the transmission of the apertures is low over most of the area and that the high-transmission areas do not overlap. The combined transmission is therefore low. This is a problem in itself as many printing systems have a throughput that is limited by the available light. It is also a problem because the light that does not reach the work-piece ends up somewhere else and may cause unwanted heating, stray-light and even radiation damage if not properly managed. Any embodiment of the invention must address the low transmission.

### Applications of the Invention

Does this invention promise to replace all other RETs (resolution enhancement techniques), one setup for everything? The answer is no because aggressive off-axis illumination and phase-shifting add contrast and thereby process latitude for specific features, e.g. gate lines. The invention has most benefit where general patterns need to be printed with equally good fidelity for all features, small and large, 1D and 2D. The typical application is masks. It may also be beneficial for ASICs where the cost of OPC processing adds to the mask cost and may become prohibitive. A third application is for direct-writing where OPC-free printing would allow for even faster turn-around times, thereby emphasizing the economic benefit of direct-writing.

### Implementation of the Filters

One way to implement the aperture transmission functions in FIG. 10 is to use a variable-transmission filter, for example created by a varying thickness of an absorbing film on a substrate. For the illuminator, the phase of the filter has no importance and a filter with a varying absorber film would work. For the projection filter the phase is important. Even as small variations from the intended function as 0.01 waves are significant and affect the optical quality of the image. A varying absorber film cannot be made without phase variations. A better alternative is to use a varying absorbing film and to compensate for the phase variation either in the surface of the substrate or by a second film with varying thickness. The absorbing film can be made from molybdenum silicide and the variation in thickness can be created during deposition or by an etching or grinding step after deposition. If an additional varying film is used, it can be of quartz and either deposited or etched or polished to the desired thickness variation. If the phase effect is corrected in the substrate surface figure, the variation can be created by selective etching or by selective polishing. A further possibility of creating gradual phase and magnitude variations is by irradiation by energetic rays such as electrons, ions and or high-energy photons.

Depending on the optical system the invention is applied to it may or may not be allowable to absorb the energy in an absorbing filter. The heating by the absorbed energy may cause the optical components to change in an unacceptable way and the absorption may in the long run change the optical properties of the absorbing film, creating a lifetime problem. A different type of filter has a graded reflectivity for the light. Again, for the illuminator filter, the phase has no effect. For the projection filter, the phase must be controlled to the desired function. The variable reflector can be designed by standard methods in the industry. A typical design would have two reflective dielectric stacks with a spacer with a varying spacer film. It can be viewed as a Fabry-Perot interferometer, where the pass band is moved in and out of the exposure wavelength range by the change in mirror spacing. This design will have as a side effect that the transmitted phase varies with transmission. As in the case with the absorbing filter, a correcting phase variation can be added to the substrate or to an auxiliary film.

In the Sigma7300 mask writer, there is an accessible aperture plane between the object (the SLM) and the image (the resist). This is because there is a relay creating an intermediate image in this system and the aperture plane in the relay is optically equivalent to the aperture plane in the final lens. The projection filter can be placed in the accessible aperture plane or close to it. Other projection systems may or may not have an accessible aperture plane. In particular, lithographic steppers and scanners have aperture planes inside the incredibly delicate final lens assembly. Furthermore, putting a filter inside the lens would generate unwanted heat and/or stray light.

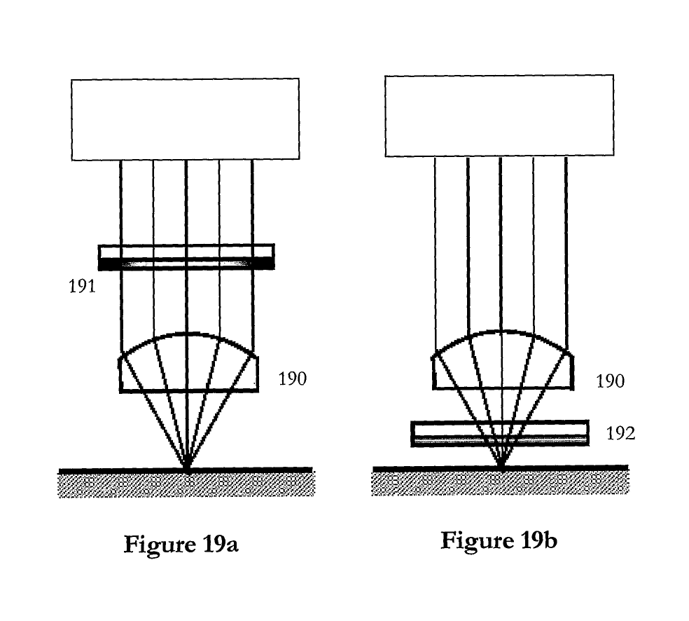

The aperture filter with a spatial variation (FIG. 19a) of the transmission can be converted to an equivalent filter with angle dependence of the transmission (FIG. 19b) and placed near one of the object or image planes. FIG. 19 shows the two different types of filters and where they can be placed. The filter with angle-dependent transmission can be designed as a more complex Fabry-Perot filter. It can have more than two reflecting stacks and spacings between them. The design can be made with commercial software such as Film Star from FTG Software, NJ, USA or The Essential Macleod from Thin Film Center Inc., AZ, USA.

### The Projection Filter

The projection filter is phase sensitive and should have a well-specified phase function versus the aperture coordinate. In many embodiments, the complex function is or can be made to be stay on the real axis. A further limitation is that it is positive real, i.e. the phase is everywhere constant zero degrees. The filter function is then an intensity transmission in the range 0-100%. A way to implement such a function is by a division-of-wavefront beam splitter, i.e. a pattern with areas that transmit the light and other areas that absorb or reflect it. The pattern creates diffracted orders that destroy the image unless they have high-enough diffraction angles to miss the image. An image field stop is inserted before the image to block unwanted stray light outside of the image and it can also block diffracted light from the pattern on the division-by-wavefront beam splitter. The design of the beam slitter has to be made with the diffraction in view and will be similar to the design of a diffractive optical element. The non-diffracted light should have an intensity consistent with the desired aperture transmission function. The first order diffraction should miss the image for all used illumination angles. The blocking portion of the beam splitter can be a metal film (e.g. chrome), and absorbing film (e.g. MoSi), a reflective thin-film stack, or not be blocking at all: a dense pattern of phase-shifted structures can be used to modulate the transmission according to the desired aperture functions. The design of the pattern can be done analytically or numerically by methods well known in physical optics and by designers of diffractive elements. The illuminator filter can also be made by a division of wavefront filter.

### The Illuminator Filter by DOE

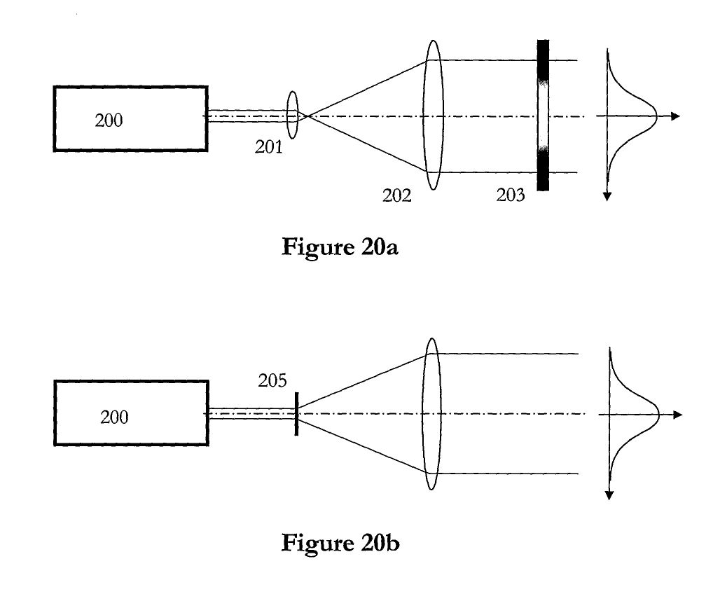

If the illuminator filter is implemented as a real filter, much of the power from the light source is thrown away. We have found that it is better to distribute the light so that essentially the entire light beam from the source reaches the object, but with the desired angular distribution. This is done as shown in FIG. 20. A diffractive optical element (DOE) spreads the beam into the desired pattern in the illuminator plane. Often, a homogenizer is needed to assure that the object plane is uniformly illuminated. With a properly designed homogenizer, the DOE can be placed before the homogenizer and the intensity distribution is preserved through it. An example is an integrating rod (“kaleidoscope”) which is angle-preserving and an imaging lenslet array homogenizer which transforms the distribution at an input plane into angle at the homogenized plane.

What has been said about transmission filters above can also be implemented as reflection filters with no change in function or principle.

### Polarization

The description above is mostly based on scalar transmission characteristics. i.e. the transmission is the same for all polarizations. A better optimization can be achieved if one or both aperture functions are defined by polarization properties. There are two reasons for this:

First it is known that the constructive interference of the light at the focus is less effective for the p than for the s polarization at high numerical aperture. This is particularly true for NA above 1, i.e. the hyper-NA condition encountered in immersion lithography. By promoting the s polarization at high angles, it is possible to maintain high contrast imaging at very high NA.

Secondly, making use of polarization resolves some of the basic trade-offs in the optimization of the aperture functions. Without polarization every point in the apertures contributes to the image of lines in all directions. With polarization control, it is possible to emphasize certain zones of the aperture for the printing in a specific direction, and another zone to another direction.

The optimization is similar to the scalar one. A polarization-aware imaging routine must be used and the four polarization parameters of the Stokes vector are allowed to vary as functions of the illuminator aperture coordinate. The projection aperture can be represented by the a Mueller matrix at each point plus an absolute phase. The Mueller matrix transforms the incoming Stokes vector in terms of intensity, degree of polarization and polarization parameters, plus it adds a phase delay to the light. The imaging routine must be capable of using the light field defined as Stokes vectors, either explicitly or implicitly.

Some thought needs to be directed to the implementation of the semicontinuous polarization filters. Polarisation in the illuminator can be achieved by a division of amplitude polarizer, i.e. splitting the beam and using different polarizing filters on different parts of the beam. For example, a fly-eye integrator can have different polarizers for different fly eye elements. Implementing a polarization-selective filter in the projection system is more difficult. One possibility is to use different polarizing filters in different areas in the projection pupil stop. A more practical way is to make use of the large spread in angles on the high-NA side of the lens and make a thin-film filter with angle dependent polarization properties. If the relative reflection of polarization states is controlled by the angle, the average reflection or transmission can be tuned with an absorbing filter. Finally, nano-optical devices with oriented microstructures can be used in the aperture planes or other planes as polarisers, waveplates or polarization-dependent scatterers. For example, a plate with fine metallic needles, 50 nm or less in width, placed in the projection pupil, will act as a full or partial transmission polarizer with a degree of polarization and a polarization direction that can change over the surface in a predetermined way.

### Derivation of the Relation Between the CD Linearity and the Interactions in the Pattern

We will now derive an approximate expression for the CD linearity for an arbitrary 1D feature. The goal is to make the change in intensity I at the first edge at x=0 zero for an incremental change in linewidth at the other edge at x=L.

Let's call the complex point (or rather line) spread function K(x,y), the electric field in the object plane E(x,y), the electric field in the image plane E(x′,y′) and the translation-invariant mutual intensity function in the object plane J(x₁−x₂, y₁−y₂).

Then according to Hopkins (B. Salik et al., J. Opt. Soc. Am. A/Vol. 13, No. 10/October 1996).

|E(x′,y′)|²=∫∫∫∫E(x,y)E*(\tilde{x},\tilde{y})J(x,\tilde{x},y,\tilde{y})K(x,x′,y,y′)K*(\tilde{x},x′,\tilde{y},y′)dxd\tilde{x}dyd\tilde{y} (1)

To get the one-dimensional expression we would need to integrate along the direction of the lines. Although (1) may not in a strict sense be separable in x and y we make the approximation for one-dimensional objects

|E(x′)|²=∫∫E(x)E*(\tilde{x})J(x,\tilde{x})K(x,x′)K*(\tilde{x},x′)dxd\tilde{x} (2)

If we add a surface element at x=L we need to replace E(x) with E(x)+E(L)δ(x−L) and we get the new intensity

|E₊(x′)|²=∫∫[E(x)+E(L)δ(x−L)][E*(\tilde{x})+E*(L)δ(\tilde{x}−L)]J(x,\tilde{x})K(\tilde{x},x′)K*(\tilde{x},x′)dxd\tilde{x}, (3)

The difference between (3) and (2)

$$Δ I ( {x}^{′} ) = {\vert {E}_{+} \vert}^{2} - {\vert E \vert}^{2} \approx E ( L ) K ( L , {x}^{′} ) \int {E}^{*} ( \tilde{x} ) J ( L , \tilde{x} ) {K}^{*} ( \tilde{x} , {x}^{′} ) d \tilde{x} + {E}^{*} ( L ) {K}^{*} ( L , {x}^{′} ) \int E ( x ) J ( L , x ) K ( x , {x}^{′} ) d x \qquad ( 4 )$$

If J is real (i.e. if the illuminator source is symmetrical around the axis) then

ΔI(x′)=2*Re(E*(L)K*(L,x′)∫E(x)J(L,x)K(x,x′)dx) (5)

Finally, place the pattern so that the probed edge is at x=0:

ΔI(0)=2*Re[E*(L)K*(L)∫E(x)J(x−L)K(x)dx] (6)

When we add the pattern element ΔL at L, the width of the feature increases by Δw₀=ΔL. On top of that the edge at x=0 moves by the effect Δw₊ of the coupling from L to 0. The total increase in feature width can be expressed as

Δw=MEEF*ΔL=Δw₀+2Δw₊ (7)

Equation (7) is a definition of MEEF (at magnification=1) and the factor 2 comes from the mutual influence between the edges. Δw₊ can be expressed as

$$\begin{matrix}Δ {w}_{+} = \pm Δ I \frac{d w / 2}{d I} \\ = \pm Δ I ( ILS * I ( 0 ) )\end{matrix} \qquad ( 8 )$$

where the sign depends on the polarity of the feature and ILS is image log-slope. We can identify

$$MEEF = 1 \pm \frac{d I}{d L} \frac{d w}{d I} \qquad ( 9 )$$

We can get the CD linearity error at the linewidth w by integration from infinity where the error vanishes by definition

$$Δ CD ( w ) = {\int }_{∞}^{w} ( MEEF ( \tilde{w} ) - 1 ) d \tilde{w} \qquad ( 10 )$$

From (10), we see that flat CD linearity is the same as MEEF=1 everywhere, i.e. ΔI(0)=0 for all linewidths L in (6). We want all features to print with flat CD linearity, i.e. ΔI(0)=0 for all L>L_{flat} regardless of the function E(x), where L_{flat} is a minimum linewidth we wish to print. Then (6) need to be zero for all functions E(x). If we could make the constant part of (6) equal to zero for all values of L we would have a perfect printing system. However, this condition is the same as having an infinitely narrow K or infinite resolution. The width of K(x) is finite and limited by the numerical aperture of the system. We need to make the best of the situation by reducing the magnitude of the expression by optimization of K(x) and J(x).

For two limiting cases of (6), incoherent J(x₁−x₂)=δ(x₁−x₂) and full coherence J(x₁−x₂)=1:

ΔI(0)=2*Re[E*(L)K*(L)E(L)K(L)]=2*|E(L)|²|K(L)|²=2*|K(L)|² (incoherent limit)

and

ΔI(0)=2*Re└E*(L)K*(L)∫E(x)K(x)dx┘=2*Re└K*(L)∫E(x)K(x)dx┘ (coherent limit)

both assuming E(L)=1.

For the incoherent case, the same K(x), i.e. the same pupil function, minimizes the CD linearity error regardless of the pattern. The fully coherent case is more complicated.

The approach we have taken to minimize the CD linearity error for all features is to make a numerical optimization through pitch variation for several families of features: isolated lines and spaces, nested lines and spaces, and constant line. See FIG. 14. Other choices would be double lines, double spaces and a line or a space adjacent to an infinite edge. Since each family probes a number of locations (see FIG. 15) and the functions K and J can not vary more rapidly than determined by the NAs of the illuminator and projection optics, it is reasonable to believe that a reasonable number of suitably chosen families of features will fence in (6) enough to make any feature print well. Optimization for a single feature or feature family will give a more ideal result for that feature, and simultaneous optimization for many features will yield a compromise. We have found that the simultaneous optimization of several feature families through varying linewidth will create a neutrally printing system with high resolution.

### Real-Time Pattern Correction

Depending on the merit function, many different compromises are possible. By choosing the merit function, one can select a compromise that is better for the particular context. If the merit function punishes all CD errors above 180 nm line or space width, and is more lenient of errors for smaller features, the result will be an optical setup with no long-range proximity effects and size errors for small features. We use such a merit function and reduce the range of interaction in the pattern. With only short-range interaction, the needed OPC corrections will be much less demanding numerically. If OPC correction is done prior to writing the pattern, it runs faster on less expensive hardware and using simpler algorithms. The most exciting prospect is that the OPC correction may be doable in real writing time (mask writer or direct writer). Another opportunity is to tune the optics so that the proximity effects in the patterns are only short-range and can be corrected in real time, e.g. using high-speed FPGAs.

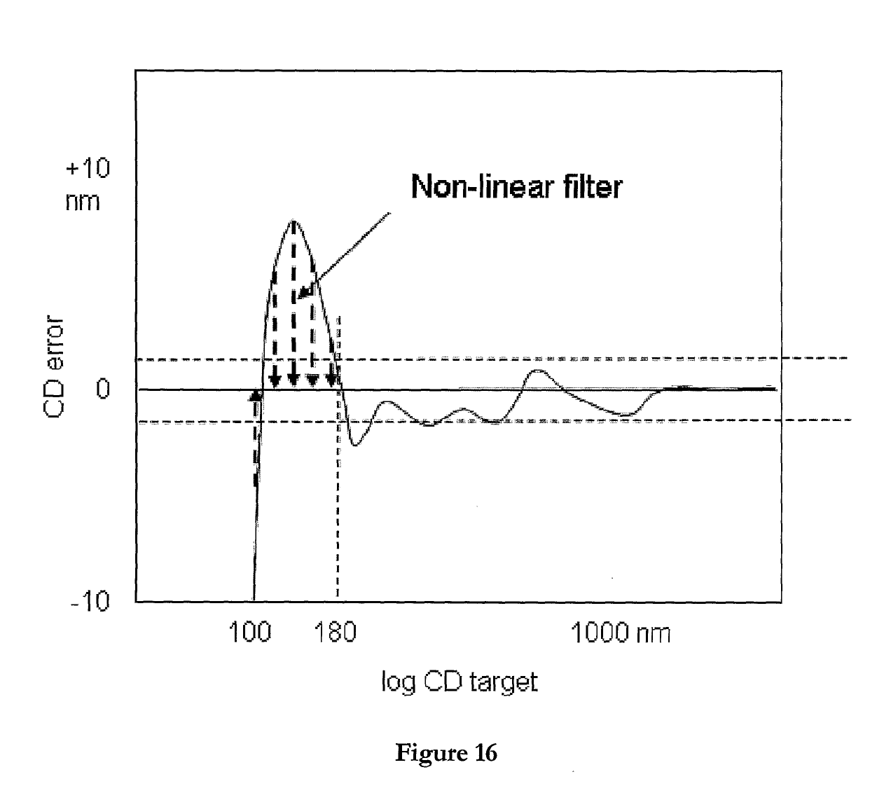

A method for performing real-time pattern correction will be outlined in the following. In a printing system based on an SLM, there is a rasterizer and certain mathematical operations on the rasterized data (described in publications and other patents and patent applications by Sandstrom at al.) that convert a vector description of the pattern to a printed pattern with high fidelity for large features. These methods include creating a bitmap based on the overlap between a pixel and the feature in vector data, using a non-linear look-up function to correct for non-linearities in the partially coherent image, converting the bitmap to account for the properties for the SLM pixel modulators, and sending the converted bitmap to the SLM. See FIG. 16. It may further involve some bitmap operations to make corners sharper and to reduce line-end shortening, to make the edge-slope of the aerial image steeper and other bitmap operations to reduce the effects of the finite pixel grid in the SLM. The SLM can be based on phase modulation, amplitude modulation, or polarization modulation and it can be transmissive or reflective. A reflective micromechanical SLM can be based on tilting mirrors or piston-action mirrors. In any case, there is a datapath and algorithms adapted to placing the edges accurately where they fall in the data, at least for large features with no proximity effects.

A real-time proximity correction scheme can be implemented as a perturbation correction to the already quite good data-to-image conversion provided by the data-path, SLM and optics. It need only correct the intensity (or E field) at the boundaries of the features. This means that we need to apply correction only to pixels at the edge or adjacent to it and they can be recognized by their grayness in an analog bitmap. Furthermore, we need only correct for the pattern inside the range of optical interaction, made small by the optimization of the optics.

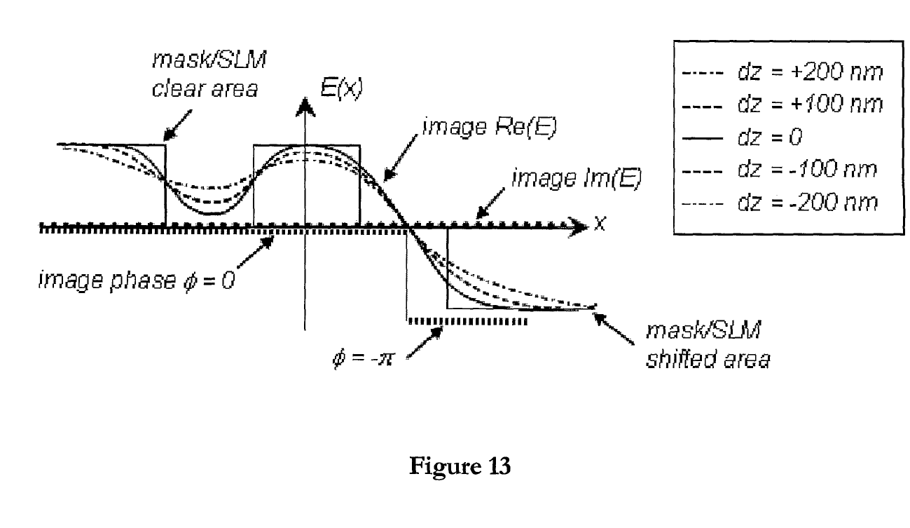

We know that the image has good quality. In particular, this means that the phase of the image is well known. FIG. 13 shows conceptually three features, two clear and one shifted by 180 degrees. It also shows the aerial image at best focus and at two focus positions on either side of best focus. If the image has good quality, the images on either side of best focus are essentially identical (lines cover each other in the figure). For this to occur, the imaginary part of the E field must be zero. The E field must be real and have a phase angle of either 0 or 180 degrees. The phase of the E-field at the edge, where the photoresist (or other light-sensitive substance) is exposed to the threshold intensity, is therefore known. It can be only 0 or 180 degrees and we know from the data (or mask) which of the two values we have. We know J and K, we know E in the object and we know the approximate value of E at the edge in the image (either 0.5+0.0 j or −0.5+0.0 j). We therefore have everything we need to calculate the perturbation from Equation (2) due to the pattern within the range of interaction. If the interaction range is small, this is only a few pixels, e.g. 7 by 7 pixels, and the calculation can be done either in a high speed general purpose processor, a signal processor, in an FPGA or in custom logic. The operations are easy to compute in parallel and to pipeline, making an implementation with high capacity possible. When several passes are printed with an offset pixel grid, it is possible to apply the correction in all passes or only in those passes where the edge pixel is close to mid-gray. A compromise with more correction in those passes where the edge is off-grid (i.e. gray) is beneficial since it does not need to imply exposures outside of the dynamic range used elsewhere in the pattern.

It is a further embodiment to provide hardware, software and firmware to do a real-time correction at small distances by determining the approximate perturbation of the intensity at an edge due to the pattern. The interactions are made short by the optimization of the optical filters. The interactions as functions of radius can be found from simulations using programs like Prolith or Solid-E or it can be deduced from CD linearity experiments.

In a preferred embodiment, one or several of the following operations are done: rasterization of vector data to a bitmap (possibly in a compressed format: zip, run-length encoded, etc.); adjustment of the bitmap for the physics of the SLM and optics; adjustment for process bias and long-range CD errors due to stray light, density, etch loading, etc.; sharpening of corners; removal of the effects of the finite pixel grid; sharpening of the edge acuity and adjustment of the exposure at the edges for proximity effects.

In a work-flow based on masks or reticles, a similar procedure can be used to simplify OPC correction and reduce overhead and lead-times. With optics tuned for short proximity range only, the OPC processing can be done more easily, involving only intra-feature correction and closest-neighbor interactions. This can be done in the vector domain or after the pattern has been converted to a bitmap. The correction can be done in the bitmap in a fashion closely analog to what has been described for the SLM, and the bitmap can then be converted back to a vector format and fed to the mask writer.

The procedure described will improve the CD accuracy of any pattern, but it will not improve process latitude by assigning alternating phase areas or adding assist features. Such operations have to be done beforehand and provided in the input data.

### Description of the “Method of Self-Consistent Optimization of Partially Coherent Imaging Systems for Improved CD Linearity” (i.e. for Micronic's Sigma Machine).

Unlike to the case of incoherent imaging system optimization [1,2], the CD linearity curves are not monotonic ones in the presence of coherent light. Thus, the optimization of CD linearity should be done at once for all CD target values and for all printing objects under consideration. The knowledge of the allowed CD linearity error δ^{±}ₙ(a) functions (the merit fences) for all CD target values a and for any objects n is the starting point. These merit fences are determined directly by the printing node requirements (i.e. by 65 nm node requirements, for instance).

The light intensity J in the image of an object n (with CD=a and at the distance δ from the edge) is bilinear form of final lens pupil P and linear form of the illuminator intensity I:

J(δ,a,n)=Iₖ(^{pp}Fₗₘ^{kp}Pₗ^{p}Pₘ*+^{sp}Fₗₘ^{ks}Pₗ^{p}Pₘ*+^{ps}Fₗₘ^{kp}Pₗ^{s}Pₘ*+^{ss}Fₗₘ^{ks}Pₗ^{s}Pₘ*)+c.c

where Iₖ is illuminator intensity distribution; Pₗ is the pupil function for s or p light polarizations; F^{k}ₗₘ(δ,a,n) is optical kernel forms, which can be calculated by using a model of polarized light propagation in a stratified media [2,3], such as air-resist, for instance. Summation over repeating indexes k, l and m is assumed. The pupils ^{s,p}P are, in general, the complex functions and asterix * means complex conjugation (c.c.). The formula is simplified in the case of polarization independent pupil P:

J(δ,a,n)=IₖFₗₘ^{k}PₗPₘ*+c.c

Summation over different polarization states at the illuminator Iₖ can be added into the formula in a similar way.

CD linearity profile δ(a) of an object n is determined implicitly by the equation:

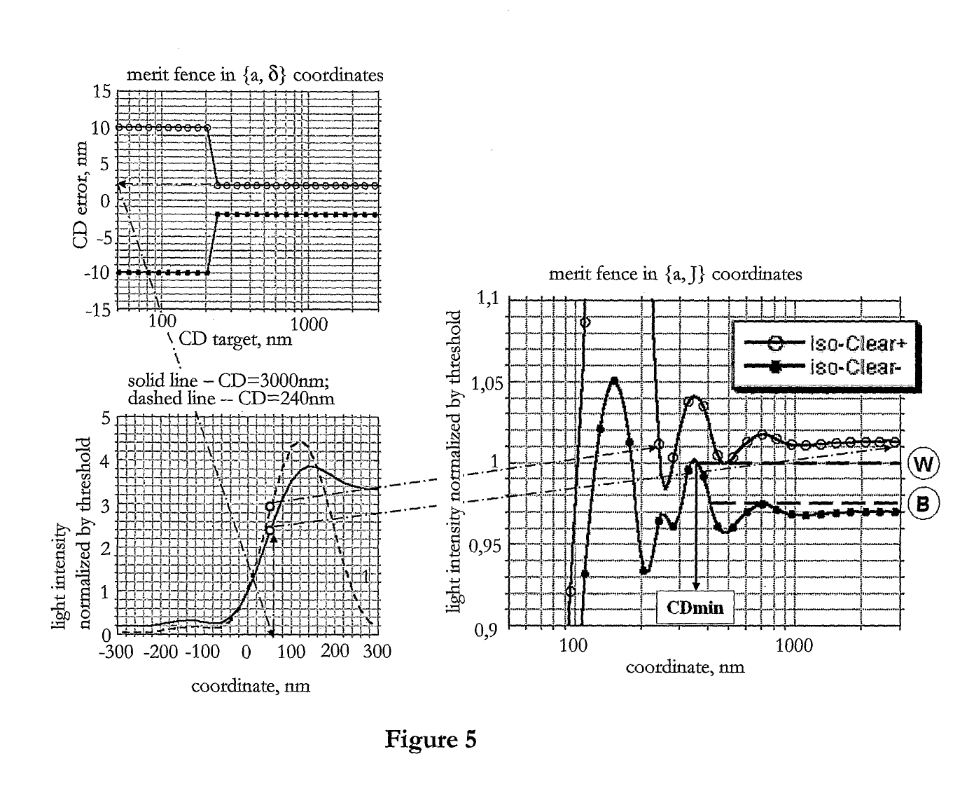

J(δ,a(δ),n)=Jₜₕᵣₑₛₕ=const

where Jₜₕᵣₑₛₕ is development intensity threshold level. Conversion of the merit fences δ^{±}ₙ(a) from the coordinates {a,δ} into the new coordinates {a,J} is possible since CD linearity error δ is much smaller than CD value a. FIG. 5 illustrates the conversion of the merit fences into the new coordinates for a given choice of illuminator and pupil functions. The preference of new coordinate system is that the CD linearity curves for all objects are transformed into horizontal straight line J(a)=Jₜₕᵣₑₛₕ for all objects there. Note, that the conversion to the new coordinates depends on the choice of the distributions of illuminator and pupils, since the knowledge of the edge profiles of the objects is used for the conversion.

The resolution CDₘᵢₙ is determined by the positive ness of the intensity gap (W−B), see FIG. 5. Indeed, the CD linearity curves of all objects will stay within their merit fences if and only if B<Jₜₕᵣₑₛₕ<W. The sets of “white” Wⱼ and “black” Bⱼ points can be chosen at new merit fences to represent them. Thus, the optimization problem becomes the standard min-max problem of maximization of the intensity gap (W−B):

$${max}_{\{ {J}_{i} , {}_{}^{s}{P}{}_{k}^{} , {}_{}^{p}{P}{}_{l}^{} \}} \{ {min}_{\{ {a}_{j} > CD min \}} ( {W}_{j} ) - {max}_{\{ {a}_{j} > CD mi n \}} ( {B}_{j} ) \} \geq 0$$

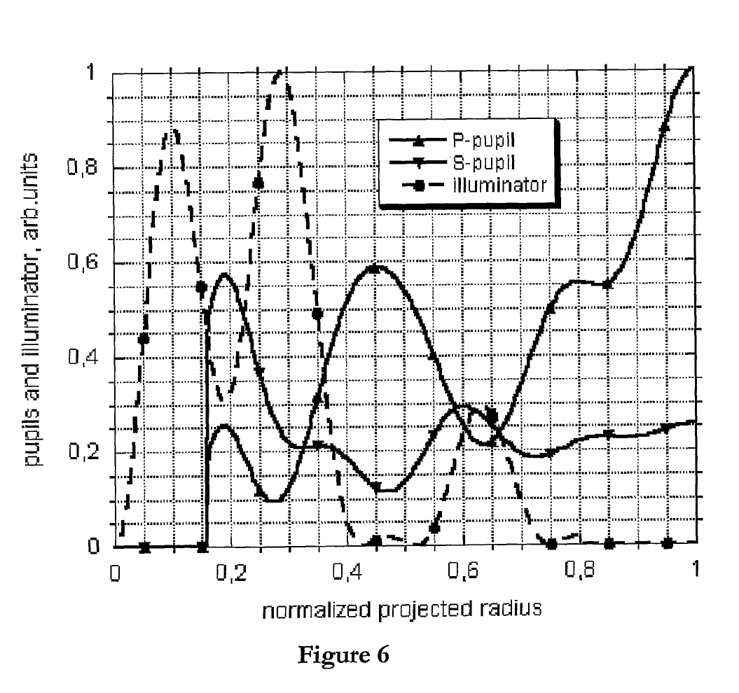

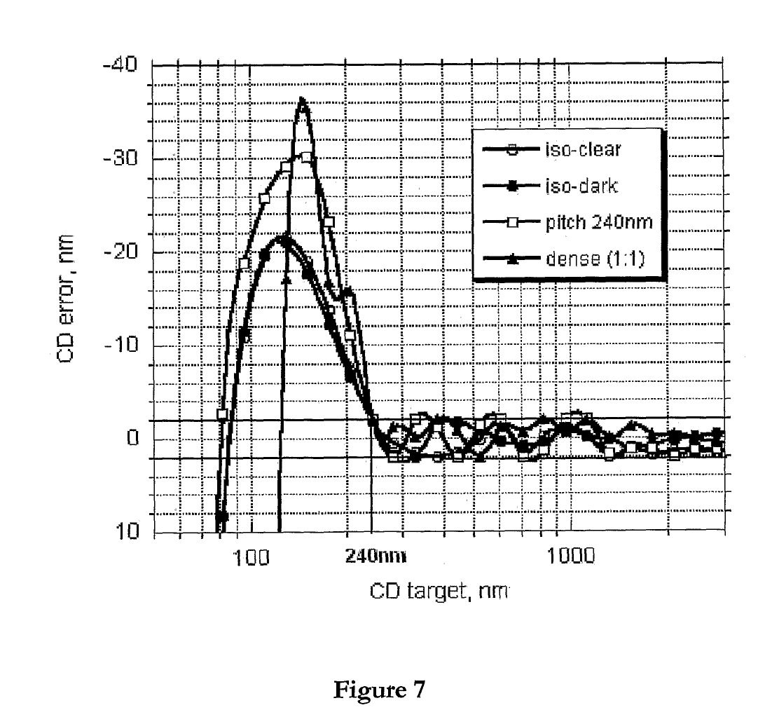

Moreover, the optimization problems appears to be an iterative quadratic linear programming problem, since all intensity forms {Wⱼ,Bⱼ} are bilinear for pupils and linear for illuminator intensity, see (2). FIGS. 6 and 7 illustrate the results of optimization for 65-nm printing node (NA=0.82 with 16% obscuration, λ=248 nm). CDₘᵢₙ=81 nm is combined with keeping strict CD linearity at CD>240 nm. The polarization pupils were used in the optimization.

The light intensity in the side lobes can be restricted by a fraction v<1 of the minimal nominal intensity level B to guarantee the absence of spike appearance in the image. This can be done by application of additional constraints:

$${max}_{\{ {a}_{j} > CD min \}} ( {W}_{j}^{spike} ) < vB$$

where Wⱼ^{spike} is the light intensity magnitude at the major side lobe

For, example, 90% “antispike” restriction was applied at the optimization in FIGS. 6 and 7. A 20 nm bias was applied as well to increase the nominal intensity level ½(W+B) itself.

If the spherical aberration caused by the presence of resist is compensated, the amplitude pupils only should be used in optimization of the printing resolution at the focal plane. This is because the forms F in (2) becomes the Hermitian ones. Thus, the optical transparency decreases in the optimized system. For instance, only 6% of the light (respectively to the case without any pupil) passes through the optimized system in FIGS. 6 and 7. This can be fixed by adding the additional restriction to the minimum allowed relative level of the nominal intensity. For instance, at least 20% transparency constraints were applied during the optimization shown in FIGS. 8-12.

The examples of self-consistency in the pupil and illuminator distributions are shown in FIGS. 8 and 10.

The optimal pupils and illuminator distributions, as well as the resulting printing efficiency, depend on the final lens obscuration. The central part of the pupil is important in optimization. Only if the obscuration is small enough, the resulting printing resolution is similar to that for the case of the lens without obscuration, compare FIGS. 9 and 11.

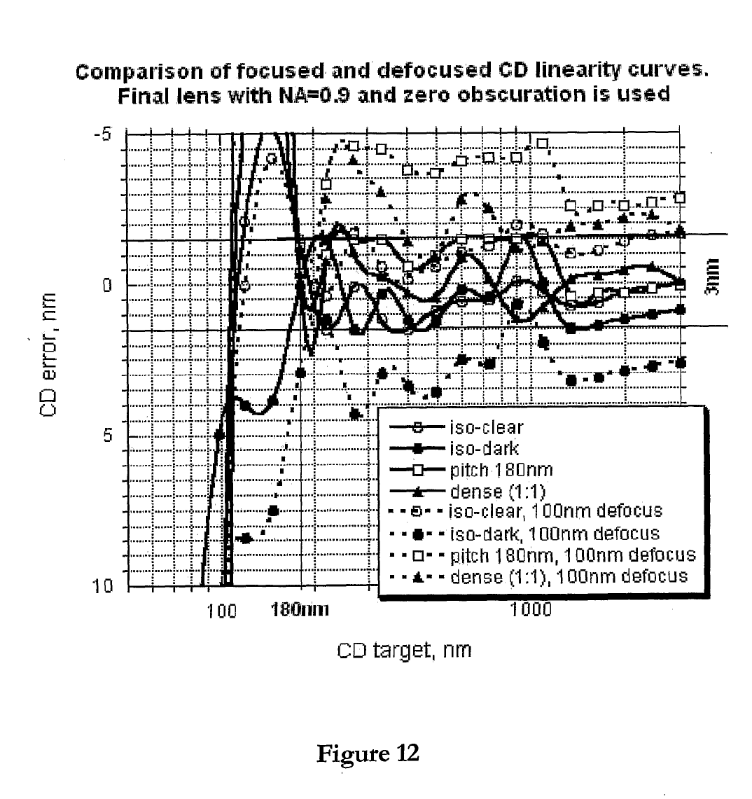

CD linearity curves can be optimized not only in the focal plane, but in whole resist layer by adding into the optimization the additional “black” and “white” points. These additional points correspond to the image in the defocused planes, at the resist top and bottom planes, for instance. FIG. 12 shows the comparison of CD linearity curves in defocused plane. As a result of such enhanced optimization, the nominal intensity ½(W+B) tends to the value of iso-focal dose in most restrictive region of the merit fence, which is not necessarily the iso-focal dose at semi-infinite edge. The bias application makes large change in nominal intensity (compare FIGS. 6 and 8) and, hence, is useful in the improvement of focal uniformity.

We claim as follows:

1. A method for printing highly accurate patterns, e.g. in microlithography, including:
providing an image object,
providing a workpiece,
providing an illuminator illuminating the object and having an illuminator aperture function,
further providing an optical projection system having in the projection pupil a pupil function and forming a partially coherent image on the workpiece,
where said projection aperture function has a continuous or semi-continuous variation with the pupil coordinate.

2. The method according to claim 1, wherein said pupil function is a complex transmission or reflection function.

3. A method according to claim 1, wherein said pupil function is a real-valued complex function.

4. A method according to claim 1, wherein said pupil function is a polarizing function.

5. The method according to claim 1, wherein said pupil function is a complex polarizing function.

6. The method according to claim 1, wherein said pupil function has two-fold symmetry.

7. The method according to claim 6, wherein said pupil function has four-fold symmetry.

8. The method according to claim 7, wherein said pupil function has eight-fold symmetry.

9. The method according to claim 8, wherein said pupil function is rotationally symmetric

10. The method according to claim 1, wherein said illuminator aperture function has a continuous or semi-continuous variation with the aperture coordinate.

11. The method according to claim 10, wherein said illuminator aperture function is an intensity function.

12. The method according to claim 10, wherein said illuminator aperture function is a polarizing function.

13. The method according to claim 10, wherein said illuminator aperture function is a function describing intensity and polarization.

14. The method according to claim 1, wherein said object is a mask.

15. The method according to claim 1, where in said object is an SLM.

16. The method according to claim 1, wherein said workpiece is a mask.

17. The method according to claim 1, wherein said workpiece is a wafer, e.g. a semiconductor wafer.

18. The method according to claim 1, wherein said workpiece is part of a display device, e.g. an active-matrix flat panel display glass sheet.

19. The method according to claim 1, wherein said pupil function is non-monotonous with radial rings.

20. The method according to claim 1, wherein said pupil function is function of a radial dependence and an azimuthal dependence.

21. The method according to claim 20. wherein said radial dependence is non-monotonous with radial rings.

22. The method according to claim 1, wherein the pupil function is changed depending on the pattern to be printed.

23. The method according to claim 1, wherein the pupil function is changed depending on the pattern to be printed.

24. The method according to claim 10, wherein the aperture illumination function is changed depending on the pattern to be printed.

25. The method according to claim 10, wherein the pupil and illumination aperture functions form a matched pair and said matched pair is exchanged depending on the pattern to be printed.

26. An apparatus for printing highly accurate patterns, e.g. in microlithography, including:
an image object,
a workpiece,
an illuminator illuminating the object and having an illuminator aperture function, an optical projection system having in the projection pupil a pupil function and forming a partially coherent image on the workpiece,
where said projection aperture function has a continuous or semi-continuous variation with the pupil coordinate.

27. The apparatus according to claim 26, wherein said pupil function is created by an absorbing filter with varying absorption over the surface of the pupil.

28. The apparatus according to claim 26, wherein said pupil function is created by a reflecting filter with a reflectance varying over the surface of the pupil.

29. The apparatus according to claim 26, wherein said pupil function is created by a computer-controlled optical element creating an illumination varying over the surface of the pupil.

30. The apparatus according to claim 29, wherein said computer-controlled optical element is a spatial light modulator.

31. The apparatus according to claim 26, wherein said illuminator aperture function is created by a grid of elements with varying size and a pitch that does not reach the workpiece.

32. The apparatus according to claim 26, wherein said illuminator aperture function is a polarization function.

33. The apparatus according to claim 32, wherein said polarizing function is created by a wave plate modifying incident polarized light.

34. The apparatus according to claim 33, wherein said wave plate has a slow axis that varies with the pupil coordinate

35. The apparatus according to claim 33, wherein said wave plate is created by a sub-resolution microstructure.

36. The apparatus according to claim 26, wherein said polarizing function is created by a polarizing element.

37. The apparatus according to claim 36, wherein said polarizing element has an axis that varies with the pupil coordinate

38. The apparatus according to claim 36, wherein said polarizing element is created by a sub-resolution microstructure.

39. The apparatus according to claim 38, wherein said sub-resolution microstructure is delineated by direct electron-beam exposure.

40. The apparatus according to claim 26, wherein said illuminator aperture function has a continuous or semi-continuous variation with the aperture coordinate.

41. The apparatus according to claim 26, wherein said illuminator aperture function is created by an absorbing filter with varying absorption over the surface of the illumination aperture.

42. The apparatus according to claim 26, wherein said illuminator aperture function is created by a reflecting filter with a reflectance varying over the surface of the illumination aperture.

43. The apparatus according to claim 26, wherein said illuminator aperture function is created by a diffractive optical element creating an illumination varying over the surface of the illumination aperture.

44. The apparatus according to claim 26, wherein said illuminator aperture function is created by a facetted optical element creating an illumination varying over the surface of the illumination aperture.

45. The apparatus according to claim 26, wherein said illuminator aperture function is created by a computer-controlled optical element creating an illumination varying over the surface of the illumination aperture.

46. An apparatus according to claim 45, wherein said computer-controlled optical element is a spatial light modulator.

47. The apparatus according to claim 26, wherein said illuminator aperture function is a polarization function.

48. The apparatus according to claim 47, wherein said polarizing function is created by splitting the beam into two polarized beams and recombining them after individual shaping to the desired illumination aperture function.

49. The apparatus according to claim 47, wherein said polarizing function is created by a waveplate modifying incident polarized light.

50. A device, e.g. a microcircuit, a magnetic head, a diffractive optical device, an image sensor or an image display device, manufactured by the method in claim 1.

51. A photomask adapted to be used with the method in claim 1.

52. A data file adapted to print a pattern using the method in claim 14.

53. A data file adapted to print a pattern using the method in claim 15.

54. A computer for performing the method in claim 15 having program instructions for performing the method in 15.

55. A computer with firmware acceleration for performing the method in 15.

56. A computer with hardware acceleration for performing the method in 15.

57. A method for printing highly accurate patterns, e.g. in microlithography, comprising the steps of
providing an image object,
providing a workpiece,
providing an illuminator illuminating the object and having an illuminator aperture function,
further providing an optical projection system having in the projection pupil a pupil function and forming a partially coherent image on the workpiece,
where the projection aperture function and the pupil function are chosen to provide good fidelity for a set of different feature types.

58. The method according to claim 57, wherein the set of features includes isolated dark lines with varying linewidth.

59. The method according to claim 57, wherein the set of features includes isolated exposed lines with varying linewidth.

60. The method according to claim 57, wherein the set of features includes dense lines and spaces with varying linewidth.

61. The method according to claim 57, wherein the set of features includes dense lines and spaces with varying linewidth and a ratio between clear and dark widths close to 1:1.

62. The method according to claim 57, wherein the set of features includes clear lines with varying linewidth between dark lines with constant width (“dark lines through pitch”).

63. The method according to claim 57, wherein the set of features includes dark lines with varying linewidth between clear lines with constant width (“clear lines through pitch”).

64. The method according to claim 57, wherein the set of features includes corners.

65. The method according to claim 57, wherein the set of features includes line ends.

66. The method according to claim 57, wherein the feature set contains at least two of the following feature types (isolated clear lines, isolated dark lines, dense lines, lines through pitch, corners, and line-ends).

67. The method according to claim 57, wherein the feature set contains at least three of the following feature types (isolated clear lines, isolated dark lines, dense lines, lines through pitch, corners, and line-ends).

68. The method according to claim 57, wherein the feature set contains at least five of the following feature types (isolated clear lines, isolated dark lines, dense lines, lines through pitch, corners, and line-ends).

69. The method according to claim 64, wherein said functions provide essentially flat CD linearity curves for at least to types of features.

70. A method for design of an illuminator aperture and a matching pupil functions in a partially coherent projection system, including:
providing a simulator for the partially coherent image,
providing a description of the optical system,
providing restrictions on the optical system,
further performing an optimization of the image fidelity by modifying said two functions.

71. The method according to claim 70, wherein said image fidelity is assessed for a set of feature types.

72. The method according to claim 71, wherein said image fidelity is assessed as CD linearity for a set of feature types.

73. A method for printing a microlithographic pattern with reduced OPC correction above a specified interaction length comprising the steps of
providing an illuminator aperture function,
providing a pupil function,
said functions being chosen to give essentially flat CD linearity for at least two and preferably a least three feature types above a linewidth essentially equal to said interaction length.

74. A method for printing a microlithographic pattern with improved fidelity and resolution, including:
providing an illuminator aperture function,
providing a pupil function,
said functions being chosen to give essentially flat CD linearity for at least two and preferably a least three feature types above a linewidth essentially equal to said interaction length
further applying OPC corrections for at least one neighboring edge within said interaction length.

75. The method according to claim 74, wherein the smallest printed figure is less than 0.35 NA/lambda.

76. The method according to claim 74, wherein the smallest prin

77. The method according to claim 74, wherein the smallest printed figure is less than 0.25 NA/lambda.

78. The method according to claim 74, wherein the OPC corrections are applied to the pattern data in the vector domain.

79. The method according to claim 74, wherein the OPC corrections are applied to the pattern data in the bitmap domain.
